(19) United States
(12) Patent Application Publication
(10) Pub. No.: US 2004/0158620 A1
(43) Pub. Date: Aug. 12, 2004

(54) Home networking communication system and method for communicating using the same

(76) Inventors: Sam Chul Ha, Kyongsangnam-do (KR); Seung Baek, Kyongsangnam-do (KR); Koon Seok Lee, Kyongsangnam-do (KR); Jeong Hyun Lim, Kyongsangnam-do (KR); Hwan Jong Choi, Kyongsangnam-do (KR); Ja ln Koo, Kyongsangnam-do (KR); Dae Woong Kim, Kyongsangnam-do (KR); Sung Hwan Kang, Kyongsangnam-do (KR)

Correspondence Address: MCKENNA LONG & ALDRIDGE LLP, 1900 K STREET, NW, WASHINGTON, DC, 20006, US

(21) Appl. No.: 10/480,107

(22) PCT Filed: Apr. 9, 2002
(86) PCT No.: PCT/KR02/00632

(30) Foreign Application Priority Data
Jun. 9, 2001 (KR) 2001/32309

(51) Int. Cl. G06F 15/173; G06F 15/16

(52) U.S. Cl. 709/219; 709/224

(57) ABSTRACT

A home networking communication system and method for communicating using the same is disclosed, which includes a main apparatus for controlling a plurality of networked peripheral apparatuses in the house by inputting a control signal from outside, and for outputting state information of the controlled peripheral apparatuses, an external apparatus for inputting control signals for controlling the plurality of peripheral apparatuses from a long distance, and web server for transmitting the control signal input from the external apparatus to the main apparatus by Internet, and for receiving the state information of the peripheral apparatuses according to the transmitted control signal, storing, monitoring the same and providing the same to the external apparatus.

### TECHNICAL FIELD

The present invention relates to a home networking system, and more particularly, to a home networking communication system and method for communication using the same, enabling to control household appliances from outside by using Internet.

### BACKGROUND ART

A home networking system, as it stands, indicates a system for networking and then controlling household appliances, such as a plurality of peripheral apparatuses in the house including PC, cellular phone, refrigerator, washing machine etc.

In other words, the system involves networking every peripheral apparatus in the house through home networking network and controlling them.

Currently, the home networking is actively under development in conforming to IEEE1394 and IEC61883 to realize controlling of the networked peripheral apparatuses in the house through one main apparatus.

More specifically, to realize home networking, a protocol that is capable of integrating many signals to one and controlling the same on IEEE1394 is required for controlling every peripheral apparatus through one main apparatus, and at the same time, users should be provided with information on the present status of each apparatus. Fortunately, the aforementioned protocol is already under development.

However, the conventional home networking communication system described above can be used in the house only. Although many attempts have been made to develop remote control systems that can be operated over Internet or telephone network, a problem remains that through the one-way communication, one cannot confirm whether household appliances are being properly operated.

In addition, if there happens to be an error in remote control for some reason, a user will not be able to trust the remote control more comfortably because he or she would worry about any possibility of mechanical troubles or getting damages on the house.

Further, there are cases that one needs to input a control signal several times in a row to control a particular kind of peripheral apparatus. This kind of complex control is impossible by using a simple control signal through one-way communication, so it becomes inevitable to simply turn on/off the power.

### DISCLOSURE OF INVENTION

It is, therefore, an object of the present invention to provide a home networking communication system and method for communicating using the same, through which a user can control and monitor the state of peripheral apparatuses in real time over bidirectional communication with peripheral apparatuses in the house by accessing to Internet through every kind of communication medium from a remote place.

Another object of the present invention is to provide a home networking communication system and method for communicating using the same, in which a main apparatus in the house accesses to relevant web server at regular intervals to download a control file that is necessary to operate other peripheral apparatuses in the house, and operates the peripheral apparatus concerned.

Still another object of the present invention is to provide a home networking communication system and method for communicating using the same, in which a main apparatus in the house transmits operations of other peripheral apparatuses in the house to web server, and then generates a web page in the web server with monitoring results of each peripheral apparatus, and provides the web page to an external apparatus in a remote place.

To achieve the above object, there is provided a home networking communication system using Internet, which includes a main apparatus for controlling a plurality of networked peripheral apparatuses in the house by inputting a control signal from outside, and for outputting state information of the controlled peripheral apparatuses, an external apparatus for inputting control signals for controlling the plurality of peripheral apparatuses from a long distance, and web server for transmitting the control signal input from the external apparatus to the main apparatus by Internet, and for receiving the state information of the peripheral apparatuses according to the transmitted control signal, storing, monitoring the same and providing the same to the external apparatus.

Preferably, the web server further includes a monitoring use database (DB) for storing state information of peripheral apparatuses that is inputted from the main apparatus and web page information for use of monitoring based on the state information, and a controlling use database for storing control signals of peripheral apparatuses that are inputted by an external apparatus.

Another aspect of the present invention provides a method for home networking communication using Internet, which includes the steps of: networking a plurality of peripheral apparatuses and installing a main apparatus for controlling the plural peripheral apparatuses; transferring present state information of the controlled peripheral apparatuses to the main apparatus at regular intervals; transmitting, at the main apparatus, the state information of each peripheral apparatus to a web server corresponding to its own IP address through Internet at regular intervals; generating a monitoring use file and further a web page for each house based on the transferred information, and providing the web page to an external apparatus; figuring out present state of a peripheral apparatus through the external apparatus from a long distance, and transmitting a controlling use file necessary for controlling the peripheral apparatus to the web server; transmitting the controlling use file having been transmitted to the web server to the main apparatus that is accessed to the web server at regular intervals; and executing an appropriate operation by transferring the transmitted file to the peripheral apparatus.

It is also possible to add a new apparatus to or delete the existing apparatus from the plurality of networked peripheral apparatuses.

Preferably, the method further includes the step of setting cycle for the main apparatus to connect to the web server short if the external apparatus and the web server are connected to each other as the main apparatus connects to the web server.

### BRIEF DESCRIPTION OF DRAWINGS

The above objects, features and advantages of the present invention will become more apparent from the following detailed description when taken in conjunction with the accompanying drawings, in which:

FIG. 1 is a schematic diagram of a home networking communication system using Internet in accordance with the present invention; and

FIG. 2 is a flow chart illustrating a home networking communication method using Internet in accordance with the present invention.

### BEST MODE FOR CARRYING OUT THE INVENTION

A preferred embodiment of the present invention will now be described with reference to the accompanying drawings.

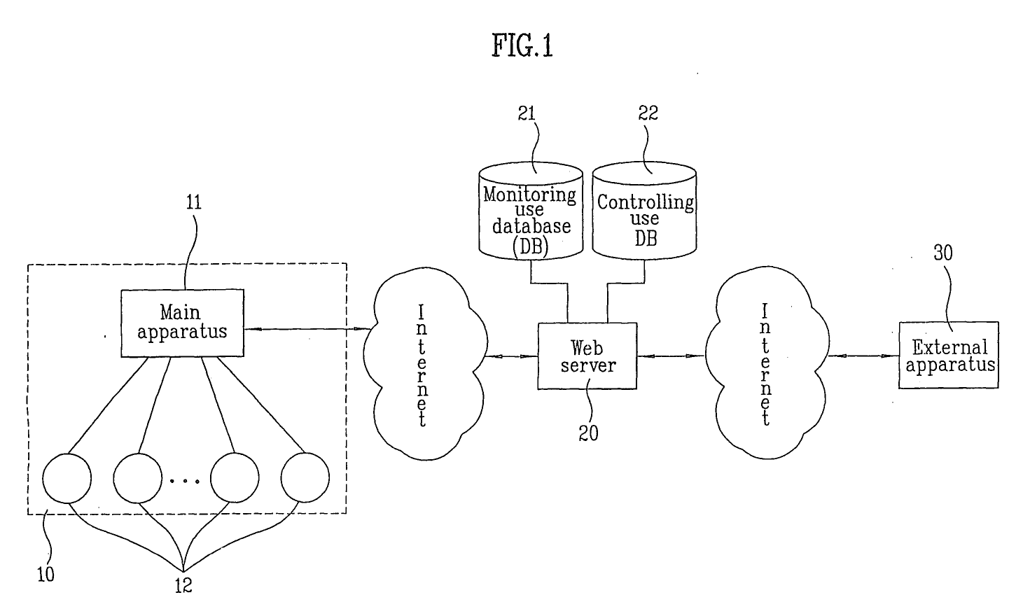

FIG. 1 is a schematic diagram of a home networking communication system using Internet in accordance with the present invention.

As depicted in the drawing, the home networking communication system includes a main apparatus 11 for controlling a plurality of networked peripheral apparatuses 12 in the house by inputting a control signal from outside, and for outputting state information of the controlled peripheral apparatuses, an external apparatus 30 for inputting control signals for controlling the plurality of peripheral apparatuses 12 from a long distance, and a web server 20 for transmitting the control signal input from the external apparatus 30 to the main apparatus 11 by Internet, and for receiving the state information of the peripheral apparatuses 12 according to the transmitted control signal, storing, monitoring the same and providing the same to the external apparatus 30.

Especially, the web server includes a monitoring use database (DB) for storing state information of peripheral apparatuses that is inputted from the main apparatus and web page information for use of monitoring based on the state information, and a controlling use database for storing control signals of peripheral apparatuses that are inputted by an external apparatus.

The peripheral apparatuses 12 inform the main apparatus 11 about their own operation states at regular intervals, and the main apparatus 11 connects to the web server 20 at regular intervals to transfer the operation state of the peripheral apparatuses 12.

In other words, main apparatus 11 receives the state information of each peripheral apparatus 12 at regular intervals, and downloads a controlling use file the external apparatus 30 inputted through Internet, and operates each peripheral apparatus 12. At this time, the main apparatus 11 has a special program that enables the apparatus to connect to the web server 20 regularly.

The web server 20, using the state information of the peripheral apparatuses 12, generates a web page having monitoring results of the present states of each peripheral apparatus 12, and stores the web page in the monitoring use database 21 in the web server 20.

Then, a user connects to the web server 20 through an external apparatus 30 from a long distance, and searches the monitoring use database 21 in the web server 20, thereby selecting a peripheral apparatus 12 to be operated and checking operation state thereof. Afterwards, the user inputs a control file for controlling the peripheral apparatus.

The inputted control file is stored in a controlling use database 22 in the web server 20, and transferred to a relevant main apparatus 10 connected to the web server 20.

The following provides more details on the home networking communication method with reference to the drawing.

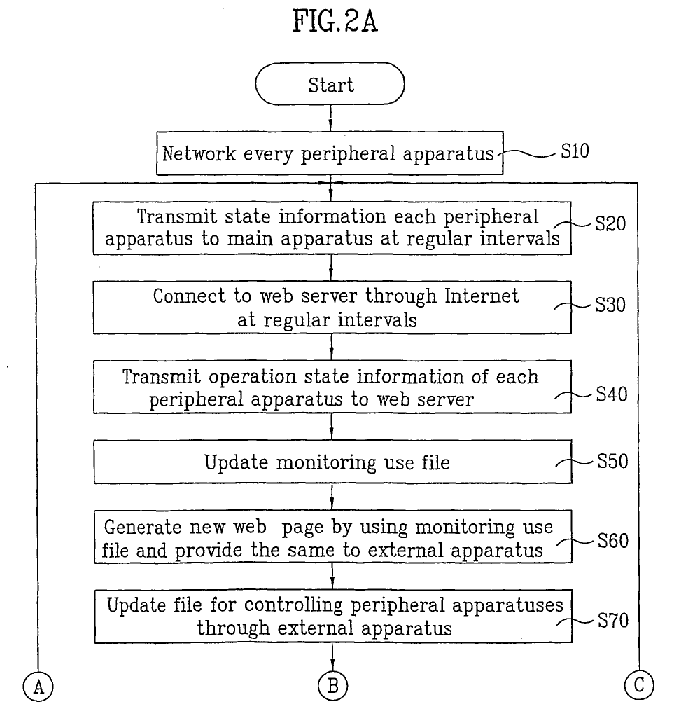

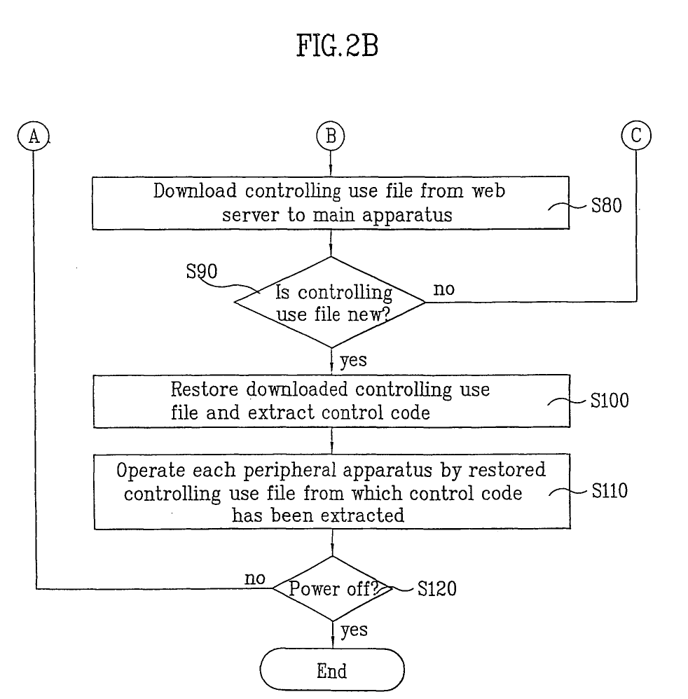

FIG. 2 is a flow chart illustrating a home networking communication method using Internet in accordance with the present invention.

As shown in the drawing, first of all, every peripheral apparatus 12 in the house is networked to one another, and main apparatus 11 is installed to control the peripheral apparatuses (S10). Here, the main apparatus 11 indicates an apparatus mounted with a controller and a storage, similar to PC that people use in general. The peripheral apparatuses 12 indicate household appliances including refrigerator, washing machine, TV, rice cooker, air conditioner, heater, audio etc. Certainly, these peripheral apparatuses can be added more or deleted from the network that connects with the main apparatus 11 of each house.

Moreover, the peripheral apparatus 12 provides its present state information, for example, operation progress condition, internal/external pressure and temperature, power on/off and so forth, to the main apparatus 11 at any time, and the main apparatus 11 stores the state information on each peripheral apparatus in the storage (S20).

Here, each peripheral apparatus 12 serially informs its own state to the main apparatus 11 at regular intervals, and for that, different time interval is set for each peripheral apparatus 12.

The main apparatus 11 connects to the web server 20 corresponding to its own IP address at regular intervals through Internet (S30), and transfers the present operation state information of each peripheral apparatus 12 to the web server 20 (S40).

Then the web server 20, based on the transmitted information, generates a monitoring use file for every house, and stores the file in the monitoring use database 21.

And, the web server 20 updates the monitoring use file by using information that is transferred from the main apparatus 11 at regular intervals (S50).

Thusly updated monitoring use file generates a web page for the exclusive use of browser by using VRML (Virtual Reality Modeling Language) that provides a java applet (Internet standard) and three-dimensional virtual environment, and provides the web page to the external apparatus 30 (S60).

Then the user connects to the web server 20 through the external apparatus 30, and generates/updates a controlling use file for controlling each peripheral apparatus through a virtual peripheral apparatus being provided by the relevant web page, and finally, stores the file in the controlling use database 22 (S70).

That controlling use file in the controlling use database 22 is later discovered by the main apparatus 11 as it connects to the web server at regular intervals.

Once it is found that the controlling use file is being stored in the controlling use database 22 inside of the web server 20, the main apparatus 11 downloads a relevant controlling file (S80).

At this time, when the main apparatus 11 is connected to the web server 20, if the web server 20 is networked to the external apparatus 30, one can conclude that a user is currently generating/updating a controlling use file by using the main apparatus 11 from the external apparatus 30. Therefore, in such case, it is preferable to set the connection cycle for the main apparatus 11 to the web server short.

After the main apparatus 11 downloads the controlling use file, the connection cycle for the main apparatus 11 to connect to the web server 29 is restored. In this way, the load on the web server 20 can be reduced, and control signals from the external apparatus 30 can be sent to the peripheral apparatus much faster.

Later, the main apparatus 11 decides whether the downloaded controlling use file is identical with the previously downloaded file or whether it is a totally new controlling use file (S90), and if the downloaded controlling use file is the same with the previous one, the main apparatus 11 deletes the downloaded controlling use file.

However, if a new controlling use file has been downloaded, the downloaded controlling use file is restored, and a control code is extracted therefrom (S100).

The extracted control code is sent to the relevant peripheral apparatus 12, and the apparatus starts operation. This operating peripheral apparatus 12 then notifies its state to the main apparatus 11 again, and the main apparatus 11 sends the state information of the peripheral apparatus 12 to the web server 20 where the monitoring use file is updated and stored in the monitoring database.

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

In conclusion, the home networking communication system and method for communicating using the same can advantageously control operation of peripheral apparatuses in the house from a long distance, and enable users to confirm the present state of each controlled peripheral apparatus in real time mode. In this way, users do not have to worry about possible errors in the operation of the peripheral apparatuses.

What is claimed is:

1. A home networking communication system using Internet, comprising:
a main apparatus for controlling a plurality of networked peripheral apparatuses in the house by inputting a control signal from outside, and for outputting state information of the controlled peripheral apparatuses;
an external apparatus for inputting control signals for controlling the plurality of peripheral apparatuses from a long distance; and
a web server for transmitting the control signal input from the external apparatus to the main apparatus by Internet, and for receiving the state information of the peripheral apparatuses according to the transmitted control signal, storing, monitoring the same and providing the same to the external apparatus.

2. The system according to claim 1, wherein the web server further comprises:
a monitoring use database (DB) for storing state information of peripheral apparatuses that is inputted from the main apparatus and web page information for use of monitoring based on the state information; and
a controlling use database (DB) for storing control signals of peripheral apparatuses that are inputted by an external apparatus.

3. A home networking communication method using Internet, comprising the steps of:
networking a plurality of peripheral apparatuses and installing a main apparatus for controlling the plural peripheral apparatuses;
transferring present state information of the controlled peripheral apparatuses to the main apparatus at regular intervals;
transmitting, at the main apparatus, the state information of each peripheral apparatus to a web server corresponding to its own IP address through Internet at regular intervals;
generating a monitoring use file and further a web page for each house based on the transferred information, and then providing the web page to an external apparatus;
figuring out present state of a peripheral apparatus through the external apparatus from a long distance, and transmitting a controlling use file necessary for controlling the peripheral apparatus to the web server;
transmitting the controlling use file having been transmitted to the web server to the main apparatus that is accessed to the web server at regular intervals; and
executing an appropriate operation by transferring the transmitted file to the peripheral apparatus.

4. The method according to claim 3, wherein a new apparatus can be added to or the existing apparatus can be deleted from the plurality of networked peripheral apparatuses.

5. The method according to claim 3, further comprising the step of: setting cycle for the main apparatus to connect to the web server short if the external apparatus and the web server are connected to each other as the main apparatus connects to the web server.
